(19) United States
(12) Patent Application Publication
(10) Pub. No.: US 2009/0179602 A1
(43) Pub. Date: Jul. 16, 2009

(54) Rotary electric machine control device, rotary electric machine control method, and rotary electric machine control program

(75) Inventors: Kazuhito Hayashi, Inazawa-shi (JP); Masaki Okamura, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/308,956

(22) PCT Filed: Jul. 18, 2007
(86) PCT No.: PCT/JP2007/064531

§ 371 Date: Dec. 30, 2008

(30) Foreign Application Priority Data
Jul. 19, 2006 (JP) 2006-196845

(51) Int. Cl. H02P 21/14

(52) U.S. Cl. 318/400.02; 318/400.15

(57) ABSTRACT

A rotary electric device control device is formed substantially by three signal process flows. A first component is a part generating a 3-phase drive signal supplied from a torque instruction value to an inverter circuit. This is the part from d,q current map to a PWM conversion. A second component detects a drive current value from a motor/generator and feeds back it to the current instruction. This corresponds to a loop for performing coordinate conversion of the drive current and inputting it as a current instruction value to a subtractor. A third component calculates a drive power and rpm of the motor/generator, acquires an estimated torque value, compensates the current instruction value according to the estimated value, and compensates a torque change. This corresponds to a power calculation, an rpm calculation, a torque estimation, and a current instruction compensation unit.

### TECHNICAL FIELD

The present invention relates to a rotary electric machine control device, a rotary electric machine control method, and a rotary electric machine control program. More particularly, the rotary electric machine control device, the rotary electric machine control method, and the rotary electric machine control program according to the present invention can compensate the torque generated by a rotary electric machine if the torque decreases.

### BACKGROUND ART

A motor or a generator equipped with a permanent magnet is subjected to a variation in magnetic flux generated by the permanent magnet, which is dependent on the temperature. In particular, in a high-temperature environment, the amount of torque that can be generated by the motor or the generator decreases due to demagnetization. Therefore, a control system for the motor or the generator is configured to estimate the magnetic flux of the permanent magnet using a temperature sensor and compensate the torque of the motor or the like.

As discussed in Japanese Patent Application Laid-Open No. Hei 10-229700, in a rotary electric machine using a permanent magnet to form a field, the proportion of demagnetization in the permanent magnet increases when the temperature rises. According to becoming smaller for an output torque actually produced by the rotary electric machine compared to a torque instruction, a present magnetic flux of the permanent magnet is estimated and a torque current instruction is corrected based on the magnetic flux estimation value. More specifically, the magnetic flux of the permanent magnet is estimated based on an output VIP of a q-axis IP control unit and calculates the torque current instruction is calculated based on the magnetic flux estimation value.

Furthermore, as discussed in Japanese Patent Application Laid-Open No. 2002-95300, when a permanent magnet synchronous motor is operating in a constant output mode with a weak field, the number of interlinked magnetic fluxes of the winding is constant. However, if the temperature of the permanent magnet rises, the number of actual interlinked magnetic fluxes of the winding decreases. As discussed in this prior art, there are methods for obtaining the number of actual interlinked magnetic fluxes of the winding. As one of the methods, a method uses a table to obtain the number of interlinked magnetic fluxes of the winding based on a detected temperature of the winding of a motor. Another method uses a calculation formula to obtain the number of interlinked magnetic fluxes of the winding based on currents Iq and Id and voltage Vq. Still another method includes considering the temperature of a winding portion of a motor to be a temperature of the magnet, obtaining currents Iq and Id with reference to a table, and setting the obtained values as current instruction values. Yet another method uses a motor model to obtain the number of interlinked magnetic fluxes of the winding.

Moreover, as discussed in Japanese Patent Application Laid-Open No. Hei 5-184192, an electric motor usable in a very low temperature environment is equipped with a heater to heat the motor, and a temperature sensor or a thermostat to detect an ambient temperature of the motor. When the temperature is lower than a limit demagnetization temperature, driving of the electric motor is stopped or the heater is operated.

Furthermore, as a system capable of estimating a torque based on the power and rotational speed of a motor and performing torque compensation based on the estimated torque, a conventional system discussed in Japanese Patent Application Laid-Open No. 2002-359996 obtains a present estimated torque value based on an estimation power obtained by a power calculation unit and the rotational speed of the motor, detects a torque deviation between the estimated torque value and a torque instruction, and performs a torque feedback operation to cause the detected torque deviation to converge to 0.

Moreover, as discussed in Japanese Patent Application Laid-Open No. 2003-88197, a torque control unit for an induction motor obtains a DC input current based on a DC voltage and a DC current supplied to a power unit, obtains an estimation torque by dividing the DC input current by a rotational speed, and sets the obtained value as an estimation torque feedback amount.

As described above, there are methods for compensating a torque reduction in a rotary electric machine occurring due to demagnetization of a permanent magnet and the like. According to one conventional method, the magnetic flux of the permanent magnet is estimated based on the temperature of the permanent magnet and the current instruction values are compensated so as to compensate a reduction in the magnetic flux. According to another conventional method, the torque of a rotary electric machine is estimated and a torque instruction value is compensated so as to compensate a torque reduction.

Regarding the method for compensating current instruction values, it is necessary for the method discussed in Japanese Patent Application Laid-Open No. Hei 10-229700 to perform special calculation processing to derive a compensation for the current instructions from the estimation for the magnetic flux. The method discussed in Japanese Patent Application Laid-Open No. 2002-95300 requires numerous tables prepared beforehand considering various temperature conditions to obtain current instruction values referring to a table. Furthermore, regarding the method for compensating a torque instruction value, the methods discussed in Japanese Patent Application Laid-Open No. 2002-359996 and Japanese Patent Application Laid-Open No. 2003-88197 may not be able to accurately perform compensations because it is difficult to discriminate a torque reduction caused by the demagnetization of the permanent magnet from a torque reduction due to other causes.

An object of the present invention is to provide, based on a new point of view, a rotary electric machine control device capable of compensating a torque change, a rotary electric machine control method, and a rotary electric machine control program. Another object of the present invention is to provide a rotary electric machine control device, a rotary electric machine control method, and a rotary electric machine control program capable of removing any causes other than the demagnetization of the permanent magnet and compensating a torque change. The following measures contribute to at least one of the above-described objects.

### DISCLOSURE OF THE INVENTION

The present invention provides a rotary electric machine control device for compensating a torque of a rotary electric machine, including voltage acquisition unit configured to acquire a drive voltage value of the rotary electric machine, current detection unit configured to detect a drive current value of the rotary electric machine, power calculation unit configured to calculate a drive power based on the acquired drive voltage value and the detected drive current value, torque estimation unit configured to obtain an estimated torque value of the rotary electric machine based on the calculated drive power and rotational speed of the rotary electric machine, and current instruction compensation unit configured to compensate a current instruction value based on a torque instruction value and the estimated torque value.

It is preferable that the current instruction compensation unit is configured to obtain a torque error based on the torque instruction value and the estimated torque value, obtain a q-axis current compensation value that can decrease the torque error to zero, and compensate a q-axis current instruction value.

It is preferable that the current instruction compensation unit is configured to obtain a q-axis current instruction value that can equalize the estimated torque value with the torque instruction value based on the torque instruction value, a corresponding q-axis current instruction value, and the estimated torque value, and is configured to compensate the q-axis current instruction value so as to be equalized with the obtained value.

It is preferable that the current instruction compensation unit is configured to obtain a torque error based on the torque instruction value and the estimated torque value, obtain a d-axis current correction value that can decrease the torque error to zero based on the torque error and a present q-axis estimated current value, and compensate a d-axis current instruction value.

It is preferable that the rotary electric machine control device further includes follow-up unit configured to perform a feedback operation for equalizing the drive current value of the rotary electric machine with the current instruction value, and follow-up judgment unit configured to determine whether the follow-up unit is in a stable follow-up state or a transient state in an operation for following up the torque instruction value, wherein when the follow-up unit is in the stable follow-up state the current instruction compensation unit performs the compensation.

It is preferable that the follow-up judgment unit is configured to determine whether the follow-up unit is in the stable follow-up state or in the transient state based on a d-axis current deviation representing a deviation between a d-axis current estimation value obtained from the drive current value of the rotary electric machine and a d-axis current instruction value, or based on a q-axis current deviation representing a deviation between a q-axis current estimation value and a q-axis current instruction value, or based on both the d-axis current deviation and the q-axis current deviation.

It is preferable that the rotary electric machine control device further includes error cause judgment unit configured to determine whether an error between the torque instruction value and the estimated torque value is caused by a predetermined control condition arbitrarily determined, wherein if the error is caused by the predetermined control condition, the compensation unit does not perform any compensation.

Furthermore, the present invention provides a rotary electric machine control device including voltage acquisition unit configured to acquire a drive voltage value of a rotary electric machine that performs a driving operation with a permanent magnet, current detection unit configured to detect a drive current value of the rotary electric machine, power calculation unit configured to calculate a drive power based on the acquired drive voltage value and the detected drive current value, torque estimation unit configured to obtain an estimated torque value of the rotary electric machine based on the calculated drive power and rotational speed of the rotary electric machine, and demagnetization rate calculation unit configured to obtain a demagnetization rate of the permanent magnet based on a comparison between a present estimated torque value estimated by the torque estimation unit and an estimated torque value having been obtained in an ordinary state, wherein the control device compensates the torque of the rotary electric machine based on the obtained demagnetization rate.

Furthermore, the present invention provides a rotary electric machine control method for compensating a torque of a rotary electric machine including a voltage acquisition step of acquiring a drive voltage value of the rotary electric machine, a current detection step of detecting a drive current value of the rotary electric machine, a power calculation step of calculating a drive power based on the acquired drive voltage value and the detected drive current value, a torque estimation step of obtaining an estimated torque value of the rotary electric machine based on the calculated drive power and rotational speed of the rotary electric machine, and a current instruction compensation step of compensating a current instruction value based on a torque instruction value and the estimated torque value.

Moreover, the present invention provides a rotary electric machine control program that, when executed by a control device of a rotary electric machine, compensates a torque of the rotary electric machine including a voltage acquisition processing procedure for acquiring a drive voltage value of the rotary electric machine, a current detection processing procedure for detecting a drive current value of the rotary electric machine, a power calculation processing procedure for calculating a drive power based on the acquired drive voltage value and the detected drive current value, a torque estimation processing procedure for obtaining an estimated torque value of the rotary electric machine based on the calculated drive power and rotational speed of the rotary electric machine, and a current instruction compensation processing procedure for compensating a current instruction value based on a torque instruction value and the estimated torque value.

As described above, at least one embodiment of the present invention acquires the drive voltage value and the drive current value of the rotary electric machine, calculates the drive power based on the values, estimates the torque of the rotary electric machine based on the calculated drive power and rotational speed of the rotary electric machine, compensates the current instruction value based on the torque instruction value and the estimated torque value, and can compensate the torque change.

Furthermore, an embodiment of the present invention obtains the torque error based on the torque instruction value and the estimated torque value, obtains the q-axis current compensation value that can reduce the torque error to zero and compensates the q-axis current instruction value. The rotary electric machine, when controlled drive based on d-axis current Id and q-axis current Iq, generates torque T expressed by a formula T=p(φIq+(Ld−Lq)IdIq} when p represents pole pairs, φ represents magnetic flux, Ld represents d-axis inductance, and Lq represents q-axis inductance. Therefore, the embodiment of the present invention obtains Iq corresponding to the torque error as a q-axis current compensation value, and compensates a present q-axis current instruction value, and can compensate the torque change.

Furthermore, an embodiment of the present invention obtains the q-axis current instruction value that can equalize the estimated torque value with the torque instruction value based on the torque instruction value, the corresponding q-axis current instruction value, and the estimated torque value, and can compensate the q-axis current instruction value so as to be equalized with the obtained value. According to the above-described formula, the torque T is proportional to the q-axis current Iq. Therefore, when the torque instruction value, the corresponding q-axis current instruction value, and the present estimated torque value are known, the q-axis current equalizing the estimated torque value with the torque instruction value can be known, and can be set as a new q-axis current instruction value, and can compensate the torque change.

Furthermore, an embodiment of the present invention obtains the torque error based on the torque instruction value and the estimated torque value, obtains the d-axis current correction value that can reduce the torque error to zero based on the torque error and the present q-axis estimated current value, and compensates the d-axis current instruction value. The embodiment of the present invention obtains Id corresponding to the torque error according to the above-described formula as a d-axis current compensation value and compensates a present d-axis current instruction value, and can compensate the torque change.

Furthermore, when the follow-up unit performs a feedback operation for equalizing the drive current value of the rotary electric machine with the current instruction value, an embodiment of the present invention determines whether the follow-up unit is in a stable follow-up state or a transient state in an operation for following up the torque instruction value. When the follow-up unit is in the stable follow-up state, the embodiment of the present invention compensates the current instruction value. If the compensation of the current instruction value is performed in the transient state, the current instruction value may be excessively increased and an actual torque may overshoot. Therefore, the embodiment of the present invention performs the compensation of the current instruction value in the stable follow-up state, thereby realized the torque compensation as intended.

Furthermore, an embodiment of the present invention determines whether the error between the torque instruction value and the estimated torque value is caused by a predetermined control condition arbitrarily determined. If the error is caused by the predetermined control condition, the compensation unit does not perform any compensation. Therefore, the embodiment of the present invention can perform torque compensation while removing any torque deviation caused by other control conditions and can remove any causes other than the demagnetization of the permanent magnet.

Moreover, at least one embodiment of the present invention acquires the drive voltage value and the drive current value of the rotary electric machine that performs a driving operation with the permanent magnet, calculates the drive power based on the values, obtains an estimated torque value of the rotary electric machine based on the calculated drive power and rotational speed of the rotary electric machine, and obtains a demagnetization rate of the permanent magnet based on a comparison between a present estimated torque value and an estimated torque value having been obtained in an ordinary state. Therefore, the embodiment of the present invention can detect the demagnetization of the permanent magnet in the rotary electric machine without using a temperature sensor monitoring the demagnetization of the permanent magnet in a low temperature environment and can compensate the torque of the rotary electric machine based on the detected demagnetization of the permanent magnet.

### BRIEF DESCRIPTION OF THE DRAWINGS

FIG. 1 illustrates a rotary electric machine control device configured to perform a driving control for a motor/generator for being installed on an automotive vehicle according to an embodiment of the present invention.

FIG. 2 illustrates a torque surge of an actual torque appearing when current instruction values are compensated based on an estimated torque value in a transient state to follow up a torque instruction value, in an embodiment of the present invention.

FIG. 3 illustrates stability of a d-axis current estimation value used for a follow-up judgment according to an embodiment of the present invention.

FIG. 4 illustrates an exemplary configuration for compensating a torque error based on compensation performed on a q-axis current instruction value according to an embodiment of the present invention.

FIG. 5 illustrates another exemplary configuration for compensating a torque error based on compensation performed on a q-axis current instruction value according to an embodiment of the present invention.

FIG. 6 illustrates an exemplary configuration for compensating a torque error based on compensation performed on a d-axis current instruction value according to an embodiment according to the present invention.

### THE BEST MODE FOR CARRYING OUT THE INVENTION

Embodiments of the present invention will be described with reference to the drawings. An example rotary electric machine described below is a three-phase synchronous rotary electric machine for being installed on an automotive vehicle, although the present invention can be applied to any other rotary electric machine. The rotary electric machine described below is a motor/generator (M/G) capable of operating as a motor and a generator, although the present invention can be applied to a rotary electric machine operable only as a motor or a generator. The rotary electric machine according to the present invention is a rotary electric machine controllable based on a d-axis current instruction value and a q-axis current instruction value. However, the number of phases is not limited to three. The example rotary electric machine performs ordinary control by feeding the drive current of the rotary electric machine back to the current instruction values, although any other control method can be used.

### Example 1

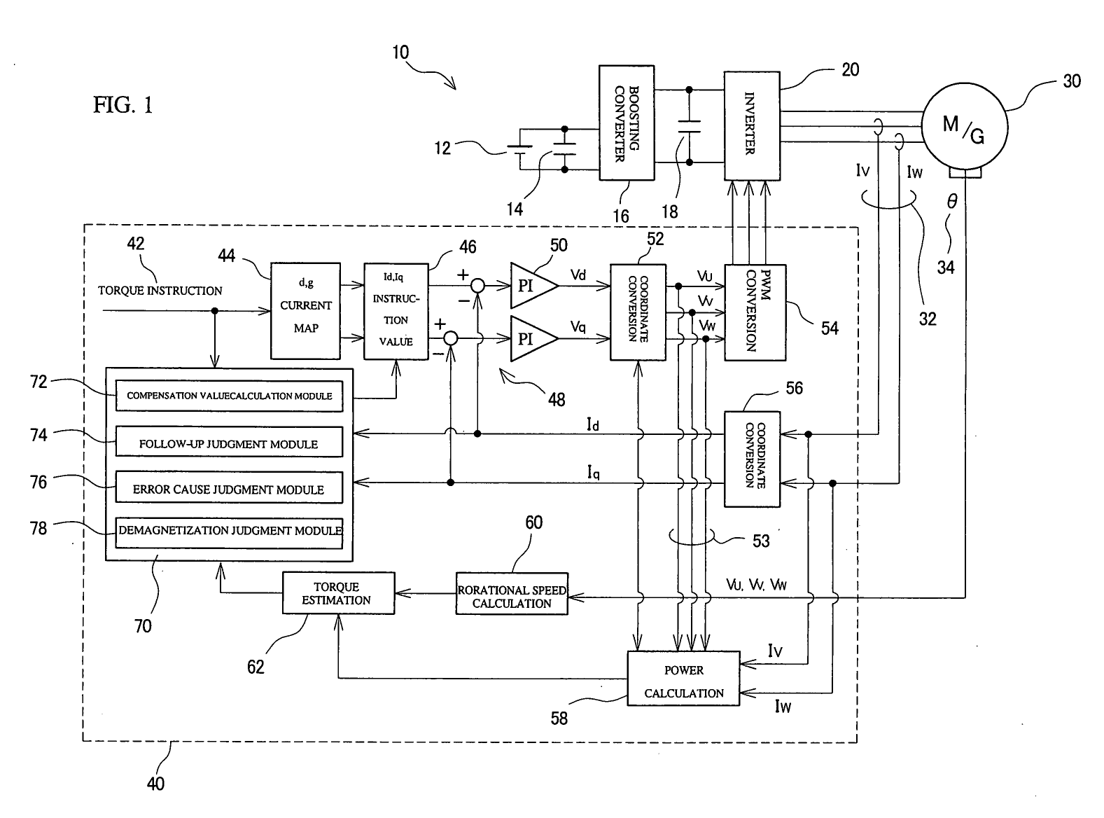

FIG. 1 illustrates a rotary electric machine control device 40 configured to perform a driving control for a motor/generator installed on an automotive vehicle. In FIG. 1, a motor/generator 30 (i.e., an object to be driven and controlled) is associated with a driving circuit 10. The motor/generator 30 is a three-phase synchronous rotary electric machine including a permanent magnet, which can operate as a driving motor capable of driving an automotive vehicle and as a regenerative generator capable of storing regenerative energy. The driving circuit 10 includes a power battery 12, a low-voltage smoothing capacitor 14, a boosting converter 16, a high-voltage smoothing capacitor 18, and an inverter 20. The driving circuit 10 supplies three-phase drive signals to the motor/generator 30.

The rotary electric machine control device 40 is a control device configured to perform calculation processing based on a torque instruction value 42, supply PWM-converted driving voltage signals to the inverter 20 of the driving circuit 10, and feed drive current values 32 back to current instructions to cause the motor/generator 30 to perform a desired driving operation. The rotary electric machine control device 40 calculates a drive power based on a drive voltage value and the drive current values 32 supplied to the motor/generator 30, and estimates a present torque of the motor/generator 30 based on the calculated drive power and a rotational speed of the motor/generator 30. The rotary electric machine control device 40 compensates current instruction values based on the estimated torque and the torque instruction value 42, to compensate a torque change of the motor/generator 30. The rotary electric machine control device 40 can be constituted by a computer capable of executing signal processing and calculation processing and the like. The above-described functions performed by the rotary electric machine control device 40 can be partly realized by a hardware configuration or a software configuration. For example, a computer can execute a rotary electric machine control program to realize the above-described functions performed by the rotary electric machine control device 40.

The rotary electric machine control device 40 performs operations roughly classified into three signal processing flows. A first constituent part of the rotary electric machine control device 40 is operative to generate three-phase drive signals based on the torque instruction value 42, and supply the generated drive signals to the inverter 20. In FIG. 1, the first constituent part of the rotary electric machine control device 40 is a portion extending from a d,q current map 44 to pulse width modulation (PWM) conversion 54.

A second constituent part of the rotary electric machine control device 40 is operative to detect the drive current values 32 from the motor/generator 30, and feed the detected current values 32 back to the current instructions. In FIG. 1, the second constituent part of the rotary electric machine control device 40 is a processing loop for converting the drive current values 32 in coordinate conversion 56 and supplying the converted signals to respective current instruction values via corresponding subtractors 48.

A third constituent part of the rotary electric machine control device 40 is operative to calculate a drive power and a rotational speed of the motor/generator 30 to obtain an estimated torque value, and compensate the current instruction values based on the estimated torque value to compensate a torque change. In FIG. 1, the third constituent part of the rotary electric machine control device 40 is a portion including power calculation 58, rotational speed calculation 60, torque estimation 62, and a current instruction compensation section 70.

The first constituent part and the second constituent part of the rotary electric machine control device 40 work to perform current feedback control for driving the motor/generator 30 in a desired state based on the torque instruction value 42, as conventionally known. More specifically, when the rotary electric machine control device 40 receives the torque instruction value 42, the rotary electric machine control device 40 searches the d,g current map 44 stored beforehand and determines a d-axis current instruction value and a q-axis current instruction value corresponding to the input torque instruction value 42. In FIG. 1, an Id,Iq instruction value 46 indicates the determined current instruction values. Therefore, the drive current values 32 detected from the motor/generator 30 are three-phase drive current values. The coordinate conversion 56 converts the drive current values 32 into d-axis current Id and q-axis current Iq. To perform feedback processing, one subtractor 48 subtracts the d-axis current Id from the Id instruction value. The other subtractor 48 subtracts the q-axis current Iq from the Iq instruction value.

A proportional integral controller 50 converts the Id instruction value having been feedback processed based on the d-axis current Id into a d-axis voltage instruction value Vd. Another proportional integral controller 50 converts the Iq instruction value having been feedback processed based on the q-axis current Iq into a q-axis voltage instruction value Vq. Coordinate conversion 52 converts the d-axis voltage instruction value Vd and the q-axis voltage instruction value Vq into three-phase drive voltage values Vu, Vv, and Vw. The power calculation 58 receives the three-phase drive voltage values 53. The PWM conversion 54 converts the three-phase drive voltage values 53 into PWM signals and supplies the converted PWM signals to the inverter 20.

The third constituent part of the rotary electric machine control device 40 compensates a torque change occurring in the motor/generator 30 based on the signals processed by the above-described first and second constituent parts. In general, the motor/generator 30 causes a torque change in an ordinary driving/controlling process. However, in this example, the third constituent part of the rotary electric machine control device 40 compensates a torque reduction occurring when demagnetization due to temperature characteristics of the permanent magnet of the motor/generator 30 occurs. The third constituent part of the rotary electric machine control device 40 can also compensate a torque change in the motor/generator 30 if it occurs due to any other cause (e.g., environmental change).

The third constituent part of the rotary electric machine control device 40 can be configured in the following manner. The power calculation 58 receives the drive current values 32 detected by current probes or other appropriate current detectors, with signal lines supplying three-phase drive currents to the motor/generator 30. If at least two phase components of the drive current values 32 are detected, the remaining three-phase component can be obtained based on calculation. According to the configuration illustrated in FIG. 1, two current components Iv and Iw are detectable. However, any other combination of the phase components can be detected. Furthermore, as described above, the power calculation 58 receives the three-phase drive voltage values 53 calculated by the coordinate conversion 52 in the above-described first constituent part. Moreover, the power calculation 58 receives an electric angle 34 of the motor/generator 30 detected by an angle sensor. The power calculation 58 calculates an estimated drive power of the motor/generator 30 based on the drive current values 32, the three-phase drive voltage values 53, and the electric angle 34.

The rotational speed calculation 60 receives the electric angle 34 of the motor/generator 30 detected by the angle sensor and calculates a rotational speed of the motor/generator 30. The torque estimation 62 receives the calculated drive power and the calculated rotational speed. The torque estimation 62 converts the rotational speed into an angular speed and divides the drive power by the angular speed to calculate an estimated torque value as a present estimated torque value of the motor/generator 30. The current instruction compensation unit 70 receives the estimated torque value. The current instruction compensation unit 70 also receives the torque instruction value 42.

The current instruction compensation unit 70 can compensate the current instruction values so as to compensate any torque change that cannot be compensated by the feedback operation performed by the above-described second constituent part of the rotary electric machine control device 40. The feedback operation performed by the above-described second constituent part of the rotary electric machine control device 40 is a feedback operation for the drive current values 32 supplied to the motor/generator 30. The torque change that cannot be compensated by the above-described feedback operation is not related to the drive current values 32. An example torque change is, as described above, a torque change caused by the demagnetization of a permanent magnet occurring when the temperature rises in the motor/generator 30.

The current instruction compensation unit 70 includes four functional modules, i.e., a compensation value calculation module 72, a follow-up judgment module 74, an error cause judgment module 76, and a demagnetization judgment module 78. The compensation value calculation module 72 receives the estimated torque value and the torque instruction value 42 and obtains a current instruction compensation value to eliminate a difference between the estimated torque value and the torque instruction value. The follow-up judgment module 74 and the error cause judgment module 76 determine whether compensating the current instructions based on the estimated torque value is appropriate and, if it is inappropriate, does not compensate the current instructions. The demagnetization judgment module 78 obtains beforehand an estimated torque value in an ordinary state where no demagnetization of the permanent magnet occurs. The demagnetization judgment module 78 compares the estimated torque value with the present estimated torque value and determines a demagnetization state of the permanent magnet.

The compensation value calculation module 72 calculates a d-axis current Id or a q-axis current Iq that can eliminate a deviation or an error between the estimated torque value and the torque instruction value, based on a formula defining the torque T of the rotary electric machine whose driving operation is controlled based on the d-axis current Id and the q-axis current Iq. More specifically, the torque T can be expressed by the formula T=p{φIq+(Ld−Lq)IdIq} when P represents pole pairs, φ represents magnetic flux, Ld represents d-axis inductance, and Lq represents q-axis inductance. If the factors p, φ, Ld, and Lq are known values, a torque error ΔT can be defined using a function of Id or Iq. Therefore, the compensation value calculation module 72 can calculate the d-axis current Id or the q-axis current Iq that can compensate the torque error ΔT. There are some methods for the above-described calculation, which are described below.

When the above-described second constituent part of the rotary electric machine control device 40 performs the current feedback operation to follow-up the torque instruction value 42, the follow-up judgment module 74 determines whether the current feedback operation is in a stable follow-up state or in a transient state. When the follow-up judgment module 74 determines that the current feedback operation is in the transient state, the actual torque may overshoot if compensation of the current instruction values is performed based on the estimated torque value. Therefore, the current instruction compensation unit 70 does not compensate any current instruction value based on the estimated torque value. When the follow-up judgment module 74 determines that the current feedback operation is in the stable follow-up state, compensation of the current instruction values is performed based on the estimated torque value.

FIG. 2 illustrates an overshoot or a torque surge of the actual torque appearing when the current instruction values are compensated based on the estimated torque value in the transient state to follow up the torque instruction value. FIG. 2, with an abscissa axis representing the time and an ordinate axis representing the torque, illustrates a relationship between an actual torque value 100 and the torque instruction value 42 together with variations of a compensated torque instruction value 43 when the compensation of the current instruction values is performed.

As illustrated in FIG. 2, in response to a change of the torque instruction value 42 at time t1, the actual torque value 100 starts changing to follow up the torque instruction value 42. In a period from time t1 to time t2, the actual torque value 100 is in a transient follow-up state. As the torque estimation 62 estimates an actual torque value in this case, if the torque estimation is accurately performed, an estimated torque value in the period from time t1 to time t2 becomes the actual torque value 100 in the period t1 to t2. Therefore, a difference between the torque instruction value 42 and the actual torque value 100 in the period t1 to t2 is obtained as a torque error 102. An amount corresponding to the torque error 102 is added to the torque instruction value 42 as a compensation amount 103 for the next sampling period (i.e., in a period from time t2 to time t3).

In this manner, when the above-described second constituent part of the rotary electric machine control device 40 performs the current feedback to follow up the torque instruction value 42, if the current instruction values are compensated based on the estimated torque value in the transient follow-up state, the compensated torque becomes excessively large compared to the torque instruction value 42.

As a result, the actual torque value 100 rapidly increases and overshoots at or after time t3. When the actual torque value 100 causes an overshoot phenomenon, a difference between the torque instruction value 42 and the actual torque value 100 in a period from time t4 to time t5 is obtained as a torque error 104. An amount corresponding to the torque error 104 is subtracted from the torque instruction value 42 as a compensation amount 105 for the next sampling period (i.e., in a period from time t5 to time t6). As a result, the actual torque value 100 causes an undershoot phenomenon.

As illustrated in FIG. 2, when the above-described second constituent part of the rotary electric machine control device 40 performs the current feedback to follow up the torque instruction value, if the current instruction values are compensated based on the estimated torque value in the transient follow-up state, the follow-up processing becomes so excessive that the actual torque value may overshoot or undershoot. Hence, when the above-described second constituent part of the rotary electric machine control device 40 performs the processing for following up the torque instruction value 42, the follow-up judgment module 74 determines whether the follow-up processing is in the stable follow-up state or the transient state. When the follow-up judgment module 74 determines that the follow-up processing is in the stable follow-up state, the current instruction compensation unit 70 compensates the current instruction values based on the estimated torque value.

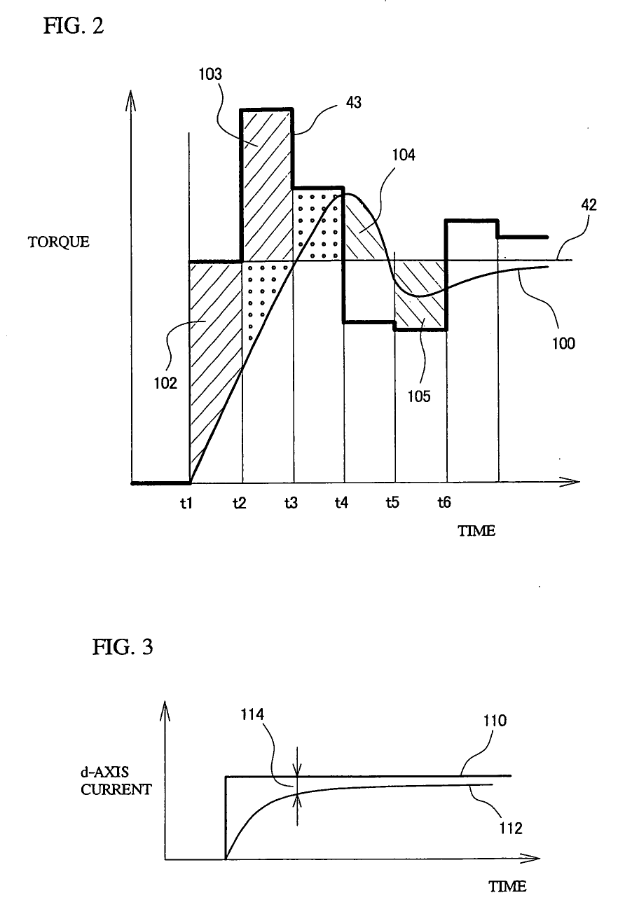

For example, the follow-up judgment module 74 can determine whether the follow-up processing is in the stable follow-up state or the transient state with reference to the stability of a d-axis current estimation value or a q-axis current estimation value derived from the drive current values 32 of the motor/generator 30. FIG. 3 illustrates the stability of the d-axis current estimation value. FIG. 3, with an abscissa axis representing the time and an ordinate axis representing the d-axis current, illustrates a d-axis current estimation value 112 varying in comparison with a d-axis current instruction value 110, which can be calculated based on the drive current values 32.

When a d-axis current deviation 114 representing a deviation between the d-axis current instruction value 110 and the d-axis current estimation value 112 is within a predetermined range, the follow-up judgment module 74 can determine that the follow-up processing is in the stable follow-up state. Furthermore, instead of using the d-axis current deviation for determining the follow-up state in the follow-up processing, the follow-up judgment module 74 can use a q-axis current deviation representing a deviation between the q-axis current instruction value and the q-axis current estimation value to determine whether the follow-up processing is in the stable follow-up state.

It is preferable that the follow-up judgment module 74 determines the follow-up state in the follow-up processing based on both the d-axis current deviation and the q-axis current deviation. For example, if either the d-axis current deviation or the q-axis current deviation exceeds a predetermined range, the follow-up judgment module 74 can determine that the follow-up processing is in the transient state. If both the d-axis current deviation and the q-axis current deviation are within the predetermined range, the follow-up judgment module 74 can determine that the follow-up processing is in the stable follow-up state.

Referring back again to FIG. 1, the error cause judgment module 76 determines whether the error between the torque instruction value and the estimated torque value is caused by a predetermined control condition arbitrarily determined. If the current instruction values are compensated based on the estimated torque value when the error is caused by the predetermined control condition, the predetermined control condition may not be accurately executed. Therefore, the error cause judgment module 76 prevents the rotary electric machine control device 40 from compensating the current instruction values based on the estimated torque value. The predetermined control condition is, for example, a vibration damping control according to which the torque instruction value is frequently changed within a short time. In this case, the error cause judgment module 76 can compare the frequency of the torque instruction per unit time with a threshold value to determine whether the error is caused by the predetermined control condition.

The demagnetization judgment module 78 obtains, beforehand, an estimated torque value in an ordinary state where no demagnetization of the permanent magnet occurs, e.g., in a state where the temperature of the permanent magnet of the motor/generator 30 is equal or more than the room temperature. The demagnetization judgment module 78 determines a demagnetization state of the permanent magnet based on a comparison between a present estimated torque value and the estimated torque value in the ordinary state. As described above, the torque T can be defined by the formula T=p{φIq+(Ld−Lq)IdIq), a torque change ΔT caused by a change Δφ in the magnetic flux φ can be expressed by a formula ΔT=pIq·Δφ. Therefore, the demagnetization judgment module 78 obtains the magnetic flux change Δφ based on the deviation ΔT between the present estimated torque value and the estimated torque value in a state where no demagnetization is caused. Therefore, if the reduction in the estimated torque value is equal or more than the torque deviation ΔT and continues for a predetermined constant period, the demagnetization judgment module 78 can determine that the permanent magnet of the motor/generator 30 is in the demagnetization state. The rotary electric machine control device 40 can compensate the current instruction values, or directly compensate the torque instruction value 42, based on the determination made by the demagnetization judgment module 78, so as to compensate the reduced torque.

The demagnetization rate of the permanent magnet can be obtained in the following manner. When the magnetic flux in an ordinary state is φ1, the motor/generator 30 generates a torque T1. When the present magnetic flux is φ2, the motor/generator 30 generates a present torque T2. The demagnetization judgment module 78 can obtain, beforehand, a ratio of a magnet torque component T_{M}=pφIq to a reluctance torque component T_{L}=P(Ld−Lq)IdIq component in the ordinary state. For example, if a relationship T_{M}=T_{L}=T₁/2 is satisfied, the demagnetization rate=(φ2−φ1)/(φ1=(T₂−T₁)/(2T_{M}) can be obtained. In this manner, the demagnetization rate of the permanent magnet can be obtained based on the estimated torque value without measuring the magnetic flux of the permanent magnet, and without measuring the temperature of the permanent magnet. The rotary electric machine control device 40 can compensate the current instruction values, or directly compensate the torque instruction value 42, based on the obtained demagnetization rate, so as to compensate the reduced torque.

### Example 2

As described above, there are some methods for obtaining the current compensation values to compensate the torque error ΔT. The second example provides a method for obtaining a q-axis current compensation value that can reduce the torque error to zero, and compensating a q-axis current instruction value. As described above, the torque T is expressed by the formula T=p{φIq+(Ld−Lq)IdIq}. When the factors other than the q-axis current Iq are known values, the torque error can be defined by the formula ΔT=p{φ+(Ld−Lq)Id)Iq=KIq. Hence, the second example performs a proportional integral control for the torque error ΔT according to the formula ΔIq=KpΔT+KiΣΔT and adds the obtained ΔIq as a q-axis current compensation value to the q-axis current instruction value, thereby compensating the torque error ΔT. Kp is a proportional gain, and Ki is an integral gain.

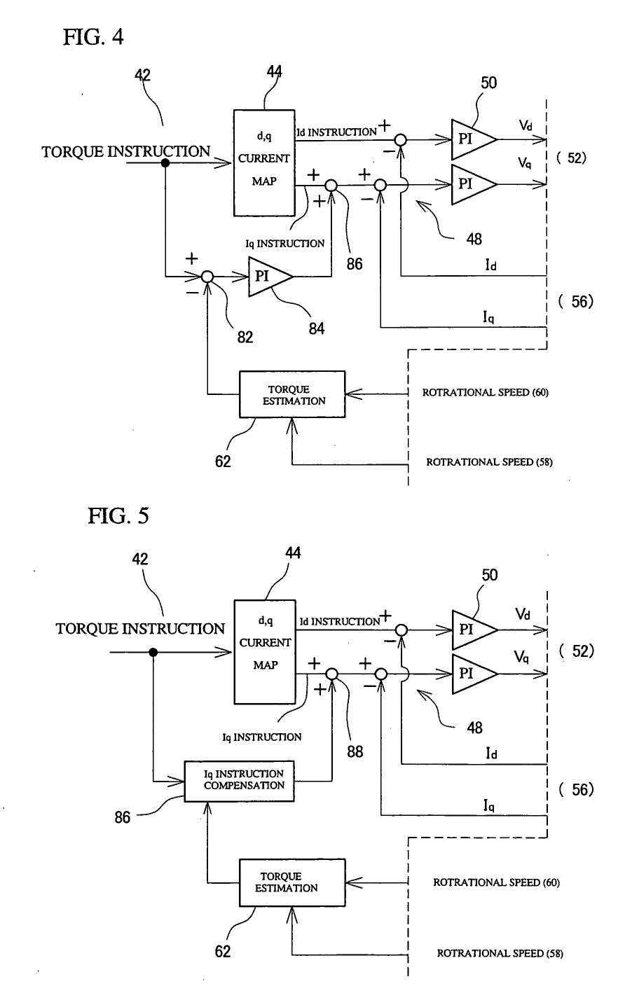

FIG. 4 illustrates a portion relating to the Id, Iq instruction value 46 illustrated in FIG. 1. A subtractor 82 receives the estimated torque value from the torque estimation 62, and calculates a difference (torque instruction value 42−estimated torque value) to obtain a torque error ΔT. A proportional integral controller 84 calculates ΔIq=KpΔT+KiΣΔT based on the obtained torque error ΔT to obtain a q-axis current compensation value ΔIq. A subtractor 86 receives the q-axis current compensation value ΔIq from the proportional integral controller 84 and calculates a sum (q-axis current instruction value+ΔIq) to obtain a new q-axis current instruction value that can compensate the torque error ΔT. In this manner, the second example obtains the q-axis current compensation value that can reduce the torque error to zero and can compensate the q-axis current instruction value.

### Example 3

A third example provides a method for obtaining a q-axis current instruction value that can equalize the estimated torque value with the torque instruction value based on the torque instruction value, a corresponding q-axis current instruction value, and the estimated torque value, and compensating the q-axis current instruction value to the obtained value. The method according to the third example is a method for obtaining the q-axis current compensation value based on calculation without performing the proportional-plus-integral control.

As described above, the torque T is expressed by the formula T=p(φIq+(Ld−Lq)IdIq}. When the factors other than the q-axis current Iq are known values, the torque can be defined by the formula T=p(φ+(Ld−Lq)Id)Iq=kIq. In this case, T₋ₑₛₜ represents a present estimated torque value under a q-axis current instruction value Iq0, T_{-com} represents a corresponding torque instruction value, and Iq1 represents a q-axis current instruction value required to equalize the estimated torque value with the torque instruction value. In this case, T₋ₑₛₜ=kIq0 and T_{-com}=kIq1 are satisfied and a relationship Iq1=T_{-com}/k=(T_{-com}/T₋ₑₛₜ)Iq0 is established. Therefore, a compensation value ΔIq of the q-axis current instruction in this case can be obtained by the formula ΔIq=Iq1−Iq0={(T_{-com}/T₋ₑₛₜ)−1}Iq0. Then, the torque error ΔT can be compensated by adding the obtained compensation value ΔIq as a q-axis current compensation value to the q-axis current instruction value.

FIG. 5 illustrates part of the configuration illustrated in FIG. 1, which is similar to FIG. 4. An Iq instruction compensation 86 receives the estimated torque value from the torque estimation 62 and the torque instruction value 42 and performs the above-described calculation to obtain a q-axis current compensation value ΔIq. A subtractor 88 receives the q-axis current compensation value ΔIq from the Iq instruction compensation 86 and calculates a sum (q-axis current instruction value+ΔIq) to obtain a new q-axis current instruction value that can compensate the torque error ΔT. In this manner, the third example obtains the q-axis current compensation value that can reduce the torque error to zero and can compensate the q-axis current instruction value.

### Example 4

A fourth example provides a method for obtaining a d-axis current correction value that can reduce the torque error to zero based on the torque error and the present q-axis estimated current value, and compensating the d-axis current instruction value. The method according to the fourth example compensates the torque error by increasing the reluctance torque. As described above, the torque T can be expressed by the formula T=p(φIq+(Ld−Lq)IdIq} The reluctance torque is given as the second term of the formula and is proportional to the d-axis current Id. The first term relating to the magnet torque includes the magnetic flux φ that is variable depending on the temperature. The inductances Ld and Lq constituting the reluctance torque are almost not dependent on the temperature. Therefore, the method according to the fourth example is almost not influenced by the temperature.

From the above-described formula, when the compensation is performed based on ΔId, the torque error ΔT is expressed by the formula ΔT=p{(Ld−Lq) Iq}ΔId if the factors other than Id are known values. Therefore, the d-axis current compensation value ΔId can be obtained based on the torque error ΔT and the present q-axis current value according to the above-described formula. The torque error ΔT can be compensated by adding the obtained d-axis current compensation value ΔId to the d-axis current instruction value. As another method for obtaining the d-axis current compensation value ΔId, a map defining a relationship between the reluctance torque and the values Id and Iq can be prepared beforehand, and the d-axis current compensation value ΔId can be obtained based on the torque error ΔT and the present q-axis current value referring to the map.

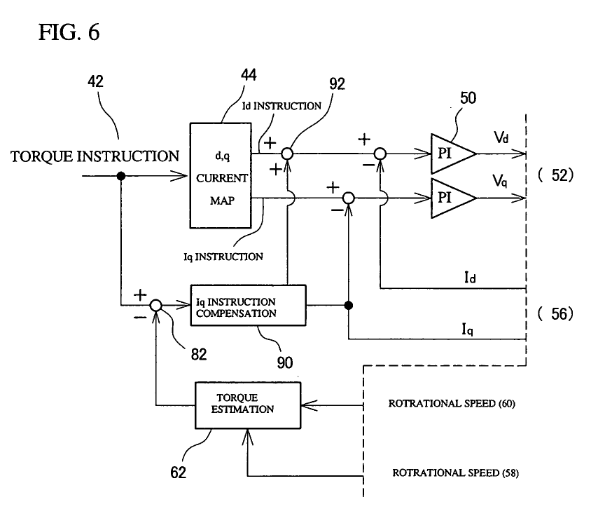

FIG. 6 illustrates part of the configuration illustrated in FIG. 1, which is similar to FIGS. 4 and 5. A subtractor 82 receives the estimated torque value from the torque estimation 62 and calculates a difference (torque instruction value 42−estimated torque value) to obtain a torque error ΔT. An Id instruction compensation 90 receives the torque error ΔT from the subtractor 82 and the present q-axis estimated current value and obtains a d-axis current compensation value ΔId that can compensate the torque error ΔT by increasing the reluctance torque according to the above-described formula. A subtractor 92 receives the d-axis current compensation value ΔId from the Id instruction compensation 90 and calculates a sum (d-axis current instruction value+ΔId) to obtain a new d-axis current instruction value that can compensate the torque error ΔT. In this manner, the fourth example obtains the d-axis current compensation value that can reduce the torque error to zero and can compensate the d-axis current instruction value.

### INDUSTRIAL APPLICABILITY

The present invention is usable for a rotary electric machine control device, a rotary electric machine control method, and a rotary electric machine control program. For example, a three-phase synchronous rotary electric machine according to the present invention can be installed on an automotive vehicle. The present invention can be used to control any other rotary electric machine.

What is claimed is:

1. A rotary electric machine control device for compensating a torque of a rotary electric machine, comprising:
voltage acquisition unit configured to acquire a drive voltage value of the rotary electric machine;
current detection unit configured to detect a drive current value from the rotary electric machine;
power calculation unit configured to calculate a drive power based on the acquired drive voltage value and the detected drive current value;
torque estimation unit configured to obtain an estimated torque value of the rotary electric machine based on the calculated drive power and rotational speed of the rotary electric machine; and
current instruction compensation unit configured to compensate a current instruction value based on a torque instruction value and the estimated torque value.

2. The rotary electric machine control device according to claim 1, wherein the current instruction compensation unit is configured to obtain a torque error based on the torque instruction value and the estimated torque value, obtain a q-axis current compensation value that can decrease the torque error to zero, and compensate a q-axis current instruction value.

3. The rotary electric machine control device according to claim 1, wherein the current instruction compensation unit is configured to obtain a q-axis current instruction value that can equalize the estimated torque value with the torque instruction value based on the torque instruction value, a corresponding q-axis current instruction value, and the estimated torque value, and is configured to compensate the q-axis current instruction value so as to be equalized with the obtained value.

4. The rotary electric machine control device according to claim 1, wherein the current instruction compensation unit is configured to obtain a torque error based on the torque instruction value and the estimated torque value, obtain a d-axis current correction value that can decrease the torque error to zero based on the torque error and a present q-axis estimated current value, and compensate a d-axis current instruction value.

5. The rotary electric machine control device according to claim 1, further comprising
follow-up unit configured to perform a feedback operation for equalizing the drive current value of the rotary electric machine with the current instruction value; and
follow-up judgment unit configured to determine whether the follow-up unit is in a stable follow-up state or a transient state in an operation for following up the torque instruction value,
wherein when the follow-up unit is in the stable follow-up state the current instruction compensation unit performs the compensation.

6. The rotary electric machine control device according to claim 5, wherein the follow-up judgment unit is configured to determine whether the follow-up unit is in the stable follow-up state or in the transient state based on a d-axis current deviation representing a deviation between a d-axis current estimation value obtained from the drive current value of the rotary electric machine and a d-axis current instruction value, or based on a q-axis current deviation representing a deviation between a q-axis current estimation value and a q-axis current instruction value, or based on both the d-axis current deviation and the q-axis current deviation.

7. The rotary electric machine control device according to claim 1, further comprising
error cause judgment unit configured to determine whether an error between the torque instruction value and the estimated torque value is caused by a predetermined control condition arbitrarily determined, wherein if the error is caused by the predetermined control condition, the compensation unit does not perform any compensation.

8. A rotary electric machine control device, comprising:
voltage acquisition unit configured to acquire a drive voltage value of a rotary electric machine that performs a driving operation with a permanent magnet;
current detection unit configured to detect a drive current value of the rotary electric machine;
power calculation unit configured to calculate a drive power based on the acquired drive voltage value and the detected drive current value;
torque estimation unit configured to obtain an estimated torque value of the rotary electric machine based on the calculated drive power and rotational speed of the rotary electric machine; and
demagnetization rate calculation unit configured to obtain a demagnetization rate of the permanent magnet based on a comparison between a present estimated torque value estimated by the torque estimation unit and an estimated torque value having been obtained in an ordinary state,
wherein the control device compensates the torque of the rotary electric machine based on the obtained demagnetization rate.

9. A rotary electric machine control method for compensating a torque of a rotary electric machine, comprising:
a voltage acquisition step of acquiring a drive voltage value of the rotary electric machine;
a current detection step of detecting a drive current value of the rotary electric machine;
a power calculation step of calculating a drive power based on the acquired drive voltage value and the detected drive current value;
a torque estimation step of obtaining an estimated torque value of the rotary electric machine based on the calculated drive power and rotational speed of the rotary electric machine; and
a current instruction compensation step of compensating a current instruction value based on a torque instruction value and the estimated torque value.

10. A rotary electric machine control program that, when executed by a control device of a rotary electric machine, compensates a torque of the rotary electric machine, comprising:
a voltage acquisition processing procedure for acquiring a drive voltage value of the rotary electric machine;
a current detection processing procedure for detecting a drive current value of the rotary electric machine;
a power calculation processing procedure for calculating a drive power based on the acquired drive voltage value and the detected drive current value;
a torque estimation processing procedure for obtaining an estimated torque value of the rotary electric machine based on the calculated drive power and rotational speed of the rotary electric machine; and
a current instruction compensation processing procedure for compensating a current instruction value based on a torque instruction value and the estimated torque value.
